(19) United States
(12) Patent Application Publication
(10) Pub. No.: US 2026/0037404 A1
(43) Pub. Date: Feb. 5, 2026

(54) QUANTITATIVELY EVALUATING GRAPHICAL USER INTERFACE (GUI) APPLICATIONS FOR ERGONOMICS AND EFFICIENCY

(71) Applicant: Hewlett Packard Enterprise Development LP, Spring, TX (US)

(72) Inventor: Phillip Noel Shea, Roseville, CA (US)

(21) Appl. No.: 18/788,601

(22) Filed: Jul. 30, 2024

(51) Int. Cl. G06F 11/34; G06F 9/451; G06V 10/75

(52) U.S. Cl. CPC G06F 11/3409; G06F 9/451; G06V 10/751

(57) ABSTRACT

In certain implementations, a computer-implemented method includes obtaining logged pixel coordinates of a sequence of input locations associated with performing a task on a user interface, converting the logged pixel coordinates of the sequence of input locations to a plurality of vectors, each vector of the plurality of vectors representing a distance between a first location and a sequential input location, each vector of the plurality of vectors indicating a direction from the first location to the sequential input location, calculating an average distance between input locations for the task, calculating an average direction change between input locations for the task, and generating an ergonomics-and-efficiency indicator from the average distance between input locations and the average direction change between input locations.

### BACKGROUND

A computer application may be a computer program or suite of computer programs designed to perform specific tasks. Examples of computer applications may include web-based applications accessible through a web browser over the Internet and/or enterprise applications used to optimize and support operations within an organization. End-users may be able to interact with the application using a graphical user interface (GUI) that provides the end-users with a visual interface for interacting with the application. This visual interface may incorporate graphical elements such as icons, buttons, windows, menus, text boxes, or other visual features.

### BRIEF DESCRIPTION OF THE DRAWINGS

Aspects of the present disclosure are best understood from the following detailed description when read with the accompanying figures.

FIG. 1 illustrates an example system for quantitatively evaluating the ergonomics and efficiency of a graphical user interface (GUI) of an application, according to some implementations.

FIGS. 2A-2B illustrate an example of quantitatively evaluating the ergonomics and efficiency of an example graphical user interface (GUI) of a GUI application in association with performance of a task 202 using the example GUI of the example GUI application, according to certain implementations.

FIG. 3 illustrates a table that shows example results of performing a quantitative evaluation process to determine the ergonomics and efficiency of a GUI associated with performing different example tasks, according to some implementations.

FIG. 4 illustrates an example method for a quantitative evaluation process of the ergonomics and efficiency of a GUI associated with performing a task, according to some implementations.

FIG. 5 illustrates an example method for a quantitative evaluation process of the ergonomics and efficiency of a GUI associated with performing a task, according to some implementations.

FIG. 6 illustrates an example method for a quantitative evaluation process of the ergonomics and efficiency of a first GUI associated with performing a first task, and a comparison with the ergonomics and efficiency of a second GUI associated with performing a second task, according to some implementations.

### DESCRIPTION

To execute a task using a computer application, a user may perform a specific sequence of steps (also referred to as a workflow) to complete the task and achieve an outcome. The user may navigate on a display component (e.g., a display screen) using various types of input, such as mouse input, keyboard input, voice input, touchscreen input, and/or other types of input, potentially in combination. For example, a user may navigate using a visual pointer (e.g., a mouse-controlled or keyboard-controlled cursor) and perform a series of movements and mouse clicks to interact with graphical elements of the application in order to perform the specific sequence of steps (e.g., workflow) to complete a given task. As another example, a user may navigate using keyboard inputs to interact with graphical elements of the application in order to perform the specific sequence of steps (e.g., workflow) to complete a given task. In some scenarios, a user may perform multiple tasks, or perform repeated tasks over a period of time, and the positioning of the graphical elements of the GUI and the associated user movements between the graphical elements for performing the multiple tasks, or perform the repeated tasks, may influence the total amount of effort extended by the user as well as the overall fatigue experienced by the user in order to complete the multiple tasks or the repeated tasks.

Certain implementations of this disclosure provide techniques for quantitatively evaluating the ergonomics and efficiency of a GUI application to perform tasks. When a task is being performed by a user interacting with the GUI application, the user's actions may be logged as each step of the task is performed. For purposes of evaluating the ergonomics and efficiency of the GUI application, the user may refer to a human user or an automated user simulating user input or otherwise interacting with the GUI application. The user's actions may include, for example, mouse movements to move the visual pointer from one graphical element to another, and mouse clicks to select or activate the graphical elements of the GUI application. A tracking application (e.g., a script, such as a PYTHON script) may be configured to collect (e.g., log) the input location of a mouse click that the user executes while performing each step of the task. In addition, the tracking application may collect the sequence of input locations generated by the user while the user performs the different steps of the task. The tracking application may convert the sequence of input locations to multiple vectors, with each vector representing a distance (e.g., in pixels) between a first location and a sequential input location. In certain implementations, the first location may be an initial cursor location or a click location, and the subsequent input location may be a click location. Each vector also may indicate a direction (e.g., in degrees) from the first location to the subsequent input location.

The tracking application may process the vectors that correspond to the task, and calculate an average distance between input locations for the task. This may be performed by summing the distances of the vectors, and then dividing the sum by the total number of input locations. The tracking application may calculate an average direction change between input locations for the task. This may be performed by first determining the differential angle between each vector and a sequential vector (e.g., by subtracting an angle of the vector from an angle of the sequential vector, until there are no more sequential vectors left to subtract from). Each differential angle may then be normalized to between-180 degrees and 180 degrees, and the absolute value of the normalized differential angle is then equal to the direction change. Next, the average direction change between input locations may be calculated by summing the direction changes for the task that were calculated previously, and then dividing the sum by one less than the total number of input locations.

An overall ergonomics-and-efficiency indicator (e.g., figure of merit) for the task can then be calculated by multiplying the average direction change between input locations by the average distance between input locations for the task. This ergonomics-and-efficiency indicator (e.g., figure of merit) can be compared to a target ergonomics-and-efficiency indicator (e.g., figure of merit) that represents the minimum ergonomics and efficiency desired to perform the task. If the overall ergonomics-and-efficiency indicator (e.g., figure of merit) is greater than the target ergonomics-and-efficiency indicator (e.g., figure of merit), the GUI application may be classified as failing to meet ergonomics and efficiency objectives for the task, and hence the GUI of the application may be identified as a candidate for redesign. In addition, in a scenario in which two or more candidate GUI designs are being tested for an application, the ergonomics and efficiency of each GUI design can be evaluated in association with performing a task. The overall ergonomics-and-efficiency indicators (e.g., figures of merit) that are calculated for each GUI design may be compared to one another, and the GUI design that has the lowest overall ergonomics-and-efficiency indicator (e.g., figure of merit) associated with performing the task may be considered the optimal, or at least better, GUI design in terms of ergonomics and efficiency.

Certain implementations of this disclosure may provide one or more technical advantages. For example, certain implementations of this disclosure may allow for the quantitative evaluation of the ergonomics and the efficiency of a GUI application associated with performing tasks. Depending on the evaluation, the system may recommend redesigning the GUI application to improve the ergonomics and efficiency of the GUI application, which may reduce a risk of repetitive stress injuries to users who perform the tasks repeatedly using the GUI application. Because of the improved ergonomics and efficiency associated with performing the tasks, the users may save time and other resources associated with performing the tasks. Because of the improved ergonomics and efficiency associated with performing the tasks, routine wear and tear to hardware components (e.g., a mouse, processor, or the like) on a client-side may be reduced, which may result in cost savings over time. Because of the improved ergonomics and efficiency associated with using the GUI application, less computational resources may be consumed from the client-side (e.g., CPU speed, memory, etc.) associated with performing the tasks, which may help to ensure faster response times and smoother interactions during the performing of the tasks.

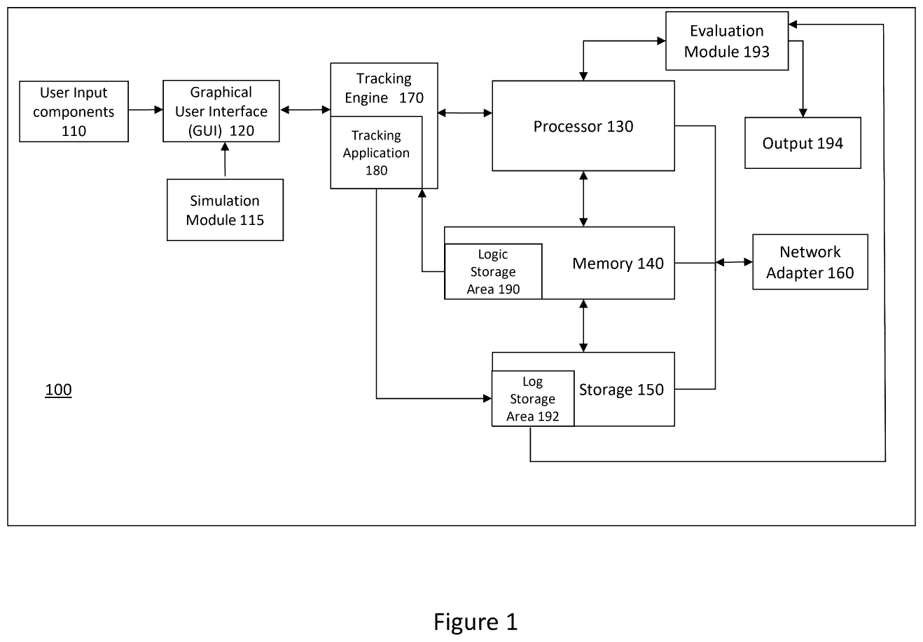

FIG. 1 illustrates an example system 100 for quantitatively evaluating the ergonomics and efficiency of a user interface of an application 101. In certain implementations, the system 100 may be a client or server that can access or host the application 101. The application 101 may be, for example, a web-based application or another type of application with which a user may interact via a visual interface. In certain implementations, the system 100 may be a computer system that provides computational resources, memory resources, storage capacity, input/output interfaces, and network connectivity to support the functionality and operation of the application 101. The system 100 may include user input components 110 that may include input devices such as keyboards, mice, touchpads, touchscreens, trackballs, styluses, or other suitable input devices, through which users interact with the application 101.

The users may be able to interact with the application 101 (e.g., using input components 110) using a graphical user interface (GUI) 120. The GUI 120 is a visual interface that users can use to interact with the application 101. This visual interface may incorporate graphical elements that may include icons, buttons, windows, menus, text boxes, or other visual features. The users may be able to interact with the GUI 120 by entering information and commands using the input components 110. The application 101 may be subsequently referred to as a GUI application. As described above, for purposes of evaluating the ergonomics and efficiency of the GUI application, a user may refer to a human user or an automated user simulating user input or otherwise interacting with the GUI application.

The system 100 may include a tracking engine 170, which may be a module that is configured to monitor and record user interactions within the GUI 120. These interactions may be facilitated using the input components 110 and can include mouse movements, clicks, keyboard inputs, touch gestures, and any other form of user inputs that the user uses to interact with the application 101. The tracking engine 170 may include a variety of components that perform specific functions in order to monitor and record user interactions within the GUI 120, such as, for example, an input receiver, which is a component that interfaces with the GUI 120 to capture raw user input data, such as mouse clicks, keyboard strokes, or touch gestures.

A tracking application 180 may be executed within the tracking engine 170. The tracking application 180 may be a specialized program that provides the specific logic and instructions for monitoring and recording user interactions with the GUI 120. In certain implementations, the tracking application 180 may be a script (e.g., written in a high-level programming language such as PYTHON or JavaScript) that is stored in a logic storage area 190 of a storage 150. The tracking application 180 may contain a set of instructions that define how to monitor, record, and process user interactions within the GUI 120. In certain implementations, the tracking engine 170 may also be used to monitor and record simulated user interactions within the GUI 120, with the tracking application 180 treating the simulated user interactions in a similar manner as real user interactions. The tracking application 180 may record the real and/or simulated user interactions in a log storage area 192 of a storage 150. These simulated user interactions may be generated using a simulation module 115 designed to generate and execute synthetic user interactions that emulate real-world human user interactions. The simulation module 115 may employ a probabilistic model to create sequences of simulated input events, such as mouse inputs, keyboard inputs, and touch gestures, based on predefined interaction patterns and user personas. These synthetic inputs may then be injected directly into the GUI 120, bypassing physical input devices, but interacting with the system 100 in a manner indistinguishable from genuine user inputs.

The system 100 may include a processor 130, which may perform a variety of operations such as rendering the GUI 120, performing computations, executing scripts, managing simulations, and managing database interactions (e.g., storing, retrieving, updating, and deleting data). The processor 130 may include one or more programmable logic devices, microprocessors, application-specific integrated circuits (ASICs), controllers, or any other suitable computing devices or resources or any combination of the preceding. The system 100 may include any suitable numbers and types of processors 130. In certain implementations, the processor 130 may be or may include a central processing unit (CPU).

The system 100 may include a memory 140, which may include a non-transitory computer readable medium that stores programming for execution by the processor 130. The logic storage area 190 is a specific section within the memory 140 that stores the script for the tracking application 180. The system 100 may also include the storage 150, which is used to store, for example, database files, static files, log files, or the like, to ensure data persistence, accessibility, and integrity. The storage 150 may include hard disk drives (HDD), solid-state drives (SSD), or the like. The log storage area 192 is a specific section within the storage 150 that is used to store the logs generated by the tracking Engine 170. These logs contain detailed records of user interactions on the GUI 120 that are captured by the tracking application 180.

The system 100 may include an evaluation module 193 that is responsible for analyzing the monitored and recorded user interactions with the GUI 120 to perform an evaluation of the GUI 120. The evaluation module 193 may receive processed data from the processor 130 and may access user interaction logs stored in the log storage area 192. The evaluation module 193 may perform analyses, apply evaluation criteria, and generate performance assessments as well as generate recommendations in regards to re-designing the GUI 120.

While the FIG. 1 shows the evaluation module 193 as part of the system 100, the evaluation module 193 can alternatively be implemented on a remote computer system. In such a configuration, the processed data from the processor 130 and the user interaction logs stored in the log storage area 192 may be communicated from the system 100 to the remote evaluation module via a network adapter 160 (described subsequently below). The results from the evaluation module 193, whether local or remote, can be sent back to an output 194 (described below) for display or reporting.

The system 100 may include the output 194, which may be a component used to display or transmit data (e.g., analysis results from the evaluation module 193) that has been collected and/or processed by other components of the system 100. The output 194 may display (e.g., using a display screen) this information in a format that is understandable to the user. The system 100 may also include the network adapter 160 that may include an Ethernet adapter, Wi-Fi adapter, or other network interfaces that facilitate communication over a network. The network adapter 160 may facilitate transmission of data between the system 100 and other devices (e.g., a server that hosts the application 101) on the network.

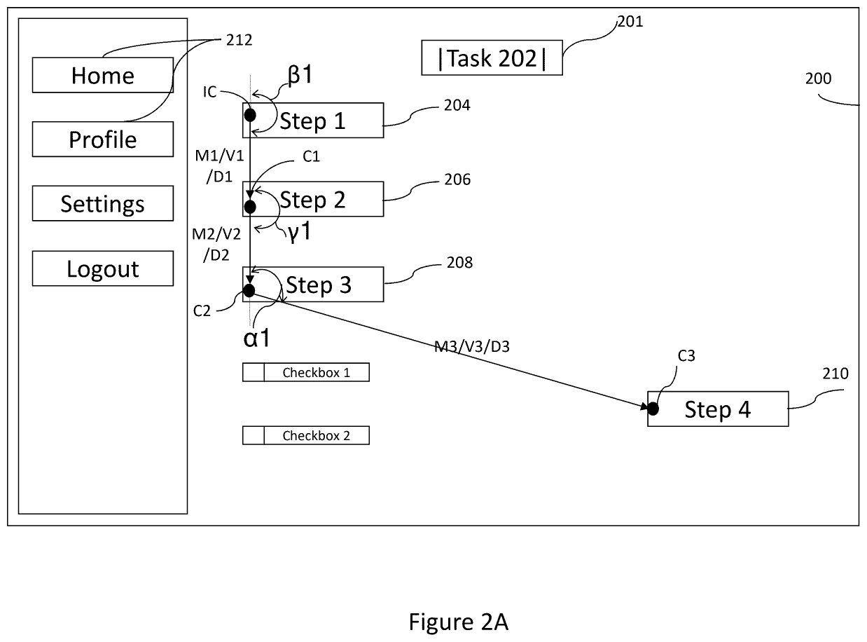

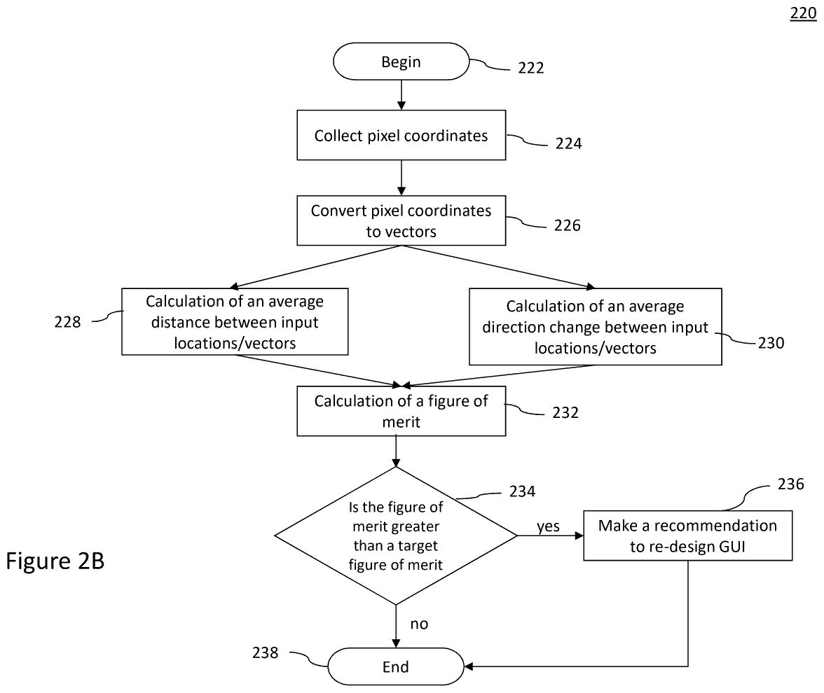

FIGS. 2A-2B illustrate an example of quantitatively evaluating the ergonomics and efficiency of an example GUI 120 (described previously with reference to FIG. 1) of an application 101 (described previously with reference to FIG. 1) in association with performance of a task 202 using the example GUI 120 of the example application 101, according to certain implementations. To perform the task 202, a specific sequence of steps (also referred to as a workflow) may be performed in order to complete the task 202 and achieve the desired outcome.

Turning to FIG. 2A, FIG. 2A illustrates an example window 200 of the GUI 120 of the application 101 associated with performing the task 202 using the application 101, according to some implementations. In FIG. 2A, the window 200 of the GUI 120 may serve as a visual container in which interactive elements (such as buttons, icons, text boxes, or the like) and other content are displayed. The window 200 is an example interface through which users may interact with the application 101. The arrangement of the interactive elements shown in the window 200 is an example implementation. This disclosure contemplates one or more windows including any numbers and any types of interactive elements arranged in any orientation, order, or position.

In certain implementations, the window 200 may include a title bar 201 that displays the title of a task (e.g., the task 202) that may be performed using the window 200. The window 200 may display interactive menu buttons 212 (or icons) that provide the user with access to frequently used functions and tools. The window 200 also may display interactive elements (e.g., interactive elements 204/206/208/210). The interactive elements 204/206/208/210 may include buttons, icons, text boxes, or the like. In certain implementations, each interactive element 204/206/208/210 may be associated with a corresponding step of the task 202. In the illustrated example, the interactive element 204, the interactive element 206, and the interactive element 208 are text boxes, and the interactive element 210 is a button.

The user may activate any of the interactive elements 204, 206, or 208 to allow the user to subsequently input relevant information into the activated text box. In certain implementations, performing the corresponding step of the task 202 includes inputting the relevant information into the activated text box. For example, in certain implementations, clicking (e.g., using a mouse, or the like) on any of the interactive elements 204/206/208 may activate the text box associated with the corresponding step of the task 202 to allow relevant information to be subsequently input into the text box. In certain implementations in which the interactive element 210 is a button, clicking (using a mouse, or the like) the interactive element 210 may activate the button which is associated with a corresponding step of the task 202. In certain implementations, performing the corresponding step of the task 202 includes clicking the interactive element 210. In an example implementation, the interactive element 204 may be associated with a first step (step 1) of the task 202. The interactive element 206 may be associated with a second step (step 2) of the task 202. The interactive element 208 may be associated with a third step (step 3) of the task 202. The interactive element 210 may be associated with a fourth step (step 4) of the task 202. Although particular types or sequences of interaction are described, this disclosure contemplates any suitable types or sequences of interaction.

The user may navigate on the window 200 using a visual pointer (e.g., a mouse-controlled or keyboard-controlled cursor) and perform a series of movements and clicks to interact with graphical elements (e.g., the interactive elements 204/206/208/210) of the application 101 in order to perform the specific sequence of steps (e.g., the first step (step 1), the second step (step 2), the third step (step 3), and the fourth step (step 4)) for completing the task 202.

In an example implementation, and as shown in FIG. 2A, upon initiating the task 202, the interactive element 204 may already be activated with a text cursor being at a first location within the text box of the interactive element 204, the first location also being referred to as an initial cursor (IC) location. In other implementations, the user may perform a click at an input location within the text box of the interactive element 204 to activate the interactive element 204. To perform step 1, the user may input relevant information into the activated text box. After the step 1 is performed, the user may then perform a first movement M1 (e.g., a vertically downward movement) using the visual pointer to the interactive element 206, and performs a click at an input location C1 within the text box of the interactive element 206 to activate the interactive element 206. Once the interactive element 206 is activated, the user may perform step 2 by inputting relevant information into the activated text box of the interactive element 206.

After the step 2 is performed, the user may then perform a second movement M2 (e.g., a vertically downward movement) using the visual pointer to the interactive element 208, and performs a click at an input location C2 within the text box of the interactive element 208 to activate the interactive element 208. Once the interactive element 208 is activated, the user may perform step 3 by inputting relevant information into the activated text box of the interactive element 208. In the example implementation shown in FIG. 2A, the first movement M1 and the second movement M2 are both in the same direction (e.g., vertically downwards). After the step 3 is performed, the user may then perform a third movement M3 using the visual pointer to the interactive element 210, and perform the step 4 by performing a click at an input location C3 on the interactive element 210 to activate the interactive element 210. In certain implementations, the input locations C1/C2/C3 are click locations. After performing the sequence of steps (e.g., the step 1, the step 2, the step 3, and the step 4 in that order) the task 202 is complete. In certain implementations, an angle measured in a clockwise direction between a vertical reference line that intersects the input location C2 from above and that does not go below the input location C2, and the direction of the third movement M3 is equal to an angle α1. In certain implementations, an angle measured in a clockwise direction between a vertical reference line that intersects the input location C1 from above and that does not go below the input location C1, and the direction of the second movement M2 is equal to an angle γ1. The angle γ1 may be equal to 180 degrees.

FIG. 2B illustrates a flowchart 220 of a process for quantitatively evaluating the ergonomics and efficiency of the GUI 120 (described previously in FIG. 1) associated with performing the task 202 using the application 101. In certain implementations, the quantitative evaluation process of FIG. 2B may be performed using system 100 of FIG. 1 and/or window 200 of FIG. 2A.

Step 222 of the flowchart 220 marks the beginning of an example of the quantitative evaluation process that was described previously in FIGS. 1-2A. In step 224, the tracking application 180 (described previously in FIG. 1) may be executed to monitor and record (e.g., log) the input location of a click that the user executes immediately before or while performing each step of the task 202. In addition, the tracking application 180 may monitor and record (e.g., log) the sequence of input locations of the clicks that the user executes while performing the different steps of the task 202.

For example, horizontal (x) and vertical (y) pixel coordinates of the initial cursor (IC) location within the text box of the interactive element 204, the input location C1 within the text box of the interactive element 206, the input location C2 within the text box of the interactive element 208, and the input location C3 on the interactive element 210 may be monitored and recorded (e.g., logged). In addition, the order in which clicks are executed (e.g., to perform the step 1, the step 2, the step 3, and the step 4) by the user also may be monitored and recorded.

In certain implementations, the tracking application 180 may be used to monitor and record input locations of simulated user interactions within the GUI 120, with the tracking application 180 treating the simulated user interactions in a similar manner as human user interactions. The tracking application 180 may record (log) the input locations of the human and/or simulated user interactions in the log storage area 192 of the storage 150.

In step 226 of the flowchart 220, the tracking application 180 may perform calculations to convert the sequence of input locations recorded in the step 224 above to multiple vectors. Each vector may represent a distance (e.g., in pixels, or the like) between a first location and a sequential input location. In some scenarios, the first location may be an initial cursor (IC) location or a click location, and the sequential input location may be a click location. For example, each vector may represent a distance between the initial cursor (IC) location and the input location C1, or between an input location (e.g., input location C1/C2) and a sequential input location (e.g., input location C2/C3). Each vector also may indicate a direction from the first location to the sequential input location. For example, each vector may indicate a direction from the initial cursor (IC) location to the input location C1, or from an input location (e.g., click location C1/C2) to a sequential input location (e.g., input location C2/C3).

As an example, the tracking application 180 may calculate the distance (e.g., in pixels, or the like) of each vector between a first input location having the coordinates (x₁, y₁) and a second sequential input location having the coordinates (x₂, y₂) using equation (1) below:

$$distance = \sqrt{{( {x}_{2} - {x}_{1} )}^{2} + {( {y}_{2} - {y}_{1} )}^{2}} \qquad ( 1 )$$

As another example, the tracking application 180 may calculate the direction (e.g., in degrees) of each vector from the first input location having the coordinates (x₁, y₁) to the second sequential input location having the coordinates (x₂, y₂) using equation (2) below:

$$direction = arctan ( \frac{{y}_{2} - {y}_{1}}{{x}_{2} - {x}_{1}} ) \qquad ( 2 )$$

For the example discussed above in FIG. 2A, in the step 226, the sequence of input locations recorded in the step 224 above may be converted to multiple vectors. The vectors may include a vector V1 between the initial cursor (IC) location within the text box of the interactive element 204 and the input location C1 within the text box of the interactive element 206. The vector V1 may have a distance D1. In addition, the vectors may include a vector V2 between the input location C1 within the text box of the interactive element 206 and the input location C2 within the text box of the interactive element 208. The vector V2 may have a distance D2. The vectors also may include a vector V3 between the input location C2 within the text box of the interactive element 208 and the input location C3 on the interactive element 210. The vector V3 may have a distance D3.

At step 228, the tracking application 180 may further process the vectors calculated in the step 226 and that correspond to the task 202, and may calculate an average distance between input locations for the task 202. This may be done by summing the distances (e.g., the distance D1+the distance D2+the distance D3) of the vectors, and then dividing the sum by the total number of input locations (e.g., input location C1, input location C2, and input location C3). In certain implementations, the tracking application 180 may calculate an average distance between vectors for the task 202. This may be done by summing the distances (e.g., the distance D1+the distance D2+the distance D3) of the vectors, and then dividing the sum by the total number of vectors (e.g., the vector V1, the vector V2, and the vector V3).

After the step 226 is performed, and prior to or after the step 228 is performed, a step 230 of the flowchart 220 may be performed in which the tracking application 180 may process the vectors that were calculated in the step 226 above that correspond to the task 202, and may calculate an average direction change between input locations for the task 202. This may be done by first determining the differential angle between each vector and a sequential vector, for example, by subtracting an angle of the vector from an angle of the sequential vector, until there are no more sequential vectors left to subtract from. Each differential angle may be normalized if appropriate to remain within a range from 180 degrees to −180 degrees. The absolute value of each differential angle then may be calculated, and this absolute value is referred to as a corresponding direction change.

For example, as shown in FIG. 2A, an angle of the vector V1 that is measured in a clockwise direction between a vertical reference line that intersects the initial cursor (IC) location from above and that does not go below the initial cursor (IC) location, and the vector V1 is equal to an angle β1. In the example implementation of FIG. 2A, the angle β1 is equal to 180 degrees. An angle of the vector V2 measured in a clockwise direction between a vertical reference line that intersects the input location C1 from above and that does not go below the input location C1, and the vector V2 is equal to an angle γ1. In the example implementation of FIG. 2A, the angle γ1 is equal to 180 degrees. An angle of the vector V3 measured in a clockwise direction between a vertical reference line that intersects the input location C2 from above and that does not go below the click location C2, and the vector V3 is equal to an angle α1. In the example implementation of FIG. 2A, the angle α1 may be equal to 120 degrees.

As shown in FIG. 2A, to determine a first differential angle between the vector V1 and the sequential vector V2, the angle of the vector V1 (e.g., angle β1) may be subtracted from the angle of the sequential vector V2 (e.g., angle γ1). In a case in which the first differential angle exceeds 180 degrees or is less than −180 degrees, the first differential angle may be normalized to remain within a range from 180 degrees to −180 degrees. This is done, for example, by adding 360 degrees to the first differential angle if the first differential angle is less than −180 degrees, or by subtracting 360 degrees from the first differential angle if the first differential angle is larger than 180 degrees. The absolute value of the first differential angle then may be calculated, which is subsequently referred to as a first direction change. If the angle of the vector V2 is expressed as aV2, and the angle of the vector is expressed as aV1, the first direction change can be expressed using the following equation (3):

$$first direction change = \vert aV 2 - aV 1 \vert \qquad ( 3 )$$

To determine a second differential angle between the vector V2 and the sequential vector V3, the angle of the vector V2 (e.g., angle γ1) may subtracted from the angle of the sequential vector V3 (e.g., angle α1). In a case in which the second differential angle exceeds 180 degrees or is less than −180 degrees, the second differential angle may be normalized to remain within a range from 180 degrees to −180 degrees as described above for the first differential angle. The absolute value of the second differential angle then may be calculated, which may be referred to subsequently as a second direction change. If the angle of the vector V2 is expressed as aV2, and the angle of the vector V3 is expressed as aV3, the second direction change can be expressed using the following equation (4):

$$second direction change = \vert aV 3 - aV 2 \vert \qquad ( 4 )$$

The average direction change between input locations may be calculated by summing the calculated direction changes for the task 202, and then dividing the sum by one less than the total number of input locations (e.g., input location C1, input location C2, and input location C3). In certain implementations, a total number of differential angles that correspond to the task 202 may be equal to one less than the total number of input locations. In certain implementations, the tracking application 180 may calculate an average direction change between vectors for the task 202. This may be done by summing the calculated direction changes for the task 202, and then dividing the sum by one less than the total number of vectors (e.g., the vector V1, the vector V2, and the vector V3). For the example shown in FIG. 2A, the first direction change may be equal to 0 degrees, and the second direction change may be equal to 60 degrees. The average direction change between input locations or the average direction change between vectors is then equal to 30 degrees.

In step 232 of the flowchart 220, the tracking application 180 may calculate an ergonomics-and-efficiency indicator. The ergonomics-and-efficiency indicator may be a comprehensive measure that assesses various aspects of user interaction with the GUI 120, including for example, user comfort, completion efficiency for the task 202, and overall GUI 120 usability. It may encompass a wide range of metrics that allow an evaluation of how effectively and comfortably users interact with the GUI 120. The ergonomics-and-efficiency indicator, for example, may include a figure of merit, which may be calculated by multiplying the average distance between input locations for the task 202 calculated above in the step 228, and the average direction change between input locations for the task 202 calculated above in the step 230. The figure of merit may be a focused metric that quantifies specific aspects of user comfort, completion efficiency for the task 202, and GUI 120 usability. In certain implementations, the ergonomics-and-efficiency indicator may also be obtained by multiplying the average distance between vectors for the task 202 calculated above in the step 228, and the average direction change between vectors for the task 202 calculated above in the step 230.

In step 234 of the flowchart 220, the evaluation module 193 may determine whether the ergonomics-and-efficiency indicator (e.g., the figure of merit) calculated above in the step 232 of the flowchart 220 is greater than a target figure of merit. The target figure of merit may represent the minimum ergonomics and efficiency desired to perform the task 202. If the ergonomics-and-efficiency indicator (e.g., the figure of merit) calculated above in the step 232 of the flowchart 220 is determined to be greater than the target figure of merit, then the GUI 120 of the application 101 may be classified as failing to meet ergonomics and efficiency objectives for the task 202, and a recommendation may be generated and displayed on the output 194 (e.g., a display screen) to redesign the GUI 120 of the application 101, as shown in a step 236 of the flowchart 220.

In certain implementations, during the step 236, the GUI 120 may be redesigned according to the recommendation, and the redesigned GUI 120 may be updated and displayed on the output 194. The redesign process for the GUI 120 may be performed (e.g., by the evaluation module 193) in order to ensure that a subsequently calculated ergonomics-and-efficiency indicator (e.g., the figure of merit) for the redesigned GUI 120 is smaller than or equal to the target figure of merit. The redesign process of the GUI 120 may include, for example, after calculating the ergonomics-and-efficiency indicator as shown in the step 232 for the current GUI 120 layout, and after determining that the ergonomics-and-efficiency indicator (e.g., the figure of merit) is greater than a target figure of merit as shown in the step 234 of the flowchart 220, identifying the interactive elements (e.g., interactive elements 204/206/208/210) associated with the vectors calculated in the step 226 that deviate most from the average distance between input locations or the average direction change between input locations, and iteratively adjusting their positions to minimize these deviations. By focusing on these outliers that contribute most to the ergonomics-and-efficiency indicator (e.g., the figure of merit) score and optimizing their placement, the GUI 120 can be systematically redesigned so that the ergonomics-and-efficiency indicator (e.g., the figure of merit) score is equal to or smaller than the target ergonomics-and-efficiency indicator score.

After the recommendation is generated in the step 236 of the flowchart 220, or after the redesigned GUI 120 is updated and displayed on the output 194, the quantitative evaluation process of the ergonomics and efficiency of the GUI 120 for the task 202 is complete. This stage of flowchart 220 is marked by the step 238.

If the ergonomics-and-efficiency indicator (e.g., the figure of merit) calculated above in the step 232 of the flowchart 220 is determined to be less than the target figure of merit, then the GUI 120 of the application 101 may be classified as meeting the desired ergonomics and efficiency objectives for the task 202, and the quantitative evaluation process of the ergonomics and efficiency of the GUI 120 for the task 202 is complete, as marked by the step 238 of the flowchart 220.

It should be understood that equations (1) through (4) described above in connection with FIG. 2B are provided as examples only. This disclosure contemplates using other suitable equations in association with quantitatively evaluating the ergonomics and efficiency of a GUI application.

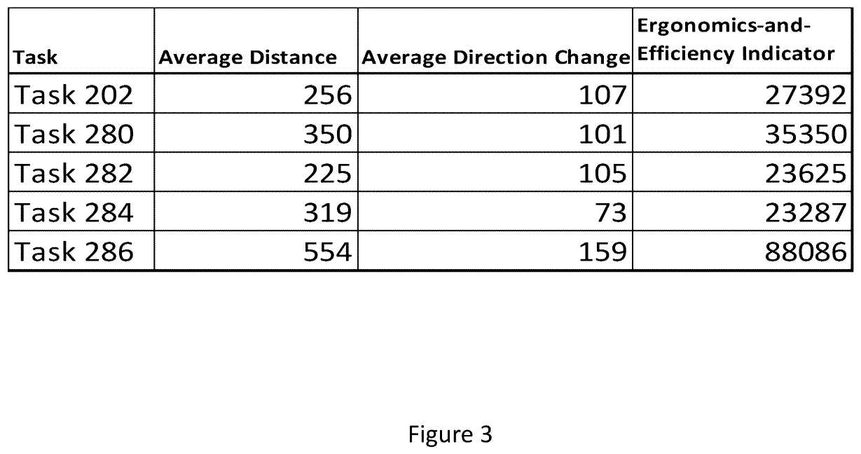

FIG. 3 illustrates a table 300 that shows example results of performing the quantitative evaluation process described previously in FIGS. 1-2B to determine the ergonomics and efficiency of the GUI 120 (described previously in FIG. 1) associated with performing different example tasks on the application 101. For example, as shown in FIG. 3, the quantitative evaluation process may be performed to carry out five example tasks (e.g., task 202, task 280, task 282, task, 284, and task 286). Each of the task 202, the task 280, the task 282, the task, the 284, and the task 286 may include a different number, and a different sequence of steps to complete the task.

Referring further to FIG. 3, the table 300 shows that for each task (e.g., task 202, task 280, task 282, task, 284, and task 286), the average distance (e.g., in pixels, or the like) between input locations is calculated as was described previously in the step 228 of the flowchart 220 (shown in FIG. 2B). In addition, the average direction change (e.g., in degrees) between input locations is calculated for each task (e.g., task 202, task 280, task 282, task, 284, and task 286) as was described previously in the step 230 of the flowchart 220 (shown in FIG. 2B). Furthermore, an ergonomics-and-efficiency indicator (e.g., a figure of merit) is calculated for each task (e.g., task 202, task 280, task 282, task, 284, and task 286) as was described previously in the step 232 of the flowchart 220. In certain implementations, the larger the ergonomics-and-efficiency indicator (e.g., the figure of merit) for a task (e.g., task 202, task 280, task 282, task, 284, and task 286), the less ergonomic and efficient it is to perform that task on the GUI 120. The table 300 shows that task 286 has the largest ergonomics-and-efficiency indicator (e.g., figure of merit), and therefore the task 286 is the least ergonomic and efficient task that is performed on the GUI 120 as compared to the other tasks. In contrast, the task 284 has the smallest ergonomics-and-efficiency indicator (e.g., figure of merit), and therefore the task 284 is the most ergonomic and efficient task that is performed on the GUI 120 as compared to the other tasks.

Certain technical advantages may be achieved by performing the quantitative evaluation process described previously in FIGS. 1-2B to determine the ergonomics and efficiency of the GUI 120 associated with performing different example tasks on the application 101. These may include allowing the quantitative evaluation of the ergonomics and efficiency of different tasks that may each include a different number, and a different sequence of steps to complete the respective task. In this way, two or more tasks that are not similar to each other and that have a different number of steps, and/or have a different sequence of steps, can be quantitatively evaluated against each other in terms of ergonomics and efficiency.

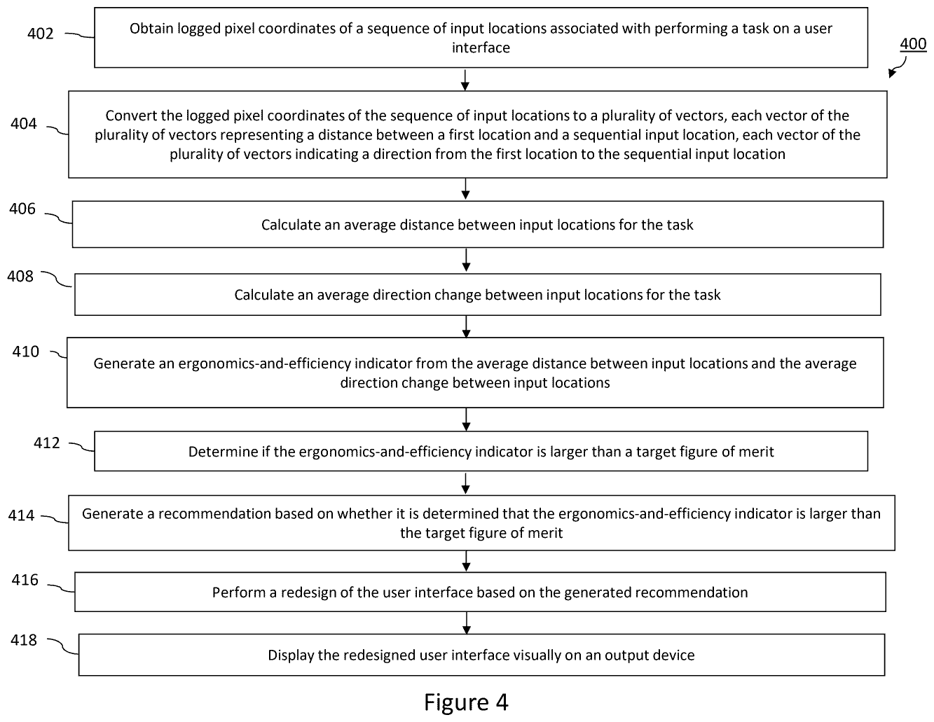

FIG. 4 illustrates an example method 400 for the quantitative evaluation process of the ergonomics and efficiency of the GUI 120 (described previously in FIG. 1) that was described previously in FIGS. 1-3. In step 402, logged pixel coordinates of a sequence of input locations associated with performing a task on a user interface may be obtained. For example, the tracking application 180, or the like, may be executed to monitor and record (e.g., log) an initial cursor (IC) location and/or an input location of a click that the user executes immediately before or while performing each step of the task 202. In addition, the tracking application 180 monitors and records (e.g., logs) the sequence of input locations of the clicks that the user executes to perform the different steps of the task 202. In certain implementations, obtaining the logged pixel coordinates may include the user logging the pixel coordinates directly within the system 100 itself, or receiving the logged pixel coordinates from an external device or source.

In step 404, the logged pixel coordinates of the sequence of input locations are converted to a multiple vectors. Each vector may represent a distance between a first location and a sequential input location. Each vector may indicate a direction from the first location to the subsequent input location. For example, the tracking application 180 may perform calculations to convert the sequence of input locations recorded in the step 224 of the flowchart 220 to multiple vectors. Each vector may represent a distance (e.g., in pixels, or the like) between the initial cursor (IC) location and the input location C1, or between an input location (e.g., input location C1/C2) and a sequential input location (e.g., input location C2/C3). Each vector also may indicate a direction from the initial cursor (IC) location to the input location C1, or from an input location (e.g., input location C1/C2) to a sequential input location (e.g., input location C2/C3).

In step 406, an average distance between input locations for the task is calculated. For example, the tracking application 180 may sum the distances (e.g., the distance D1+the distance D2+the distance D3 shown in FIG. 2A) of the vectors, and then divide the sum by the total number of input locations (e.g., input location C1, input location C2, and input location C3 shown in FIG. 2A).

In step 408, an average direction change between input locations is calculated for the task. For example, the tracking application 180 may calculate an average direction change between input locations for the task 202. This may be done by summing the calculated direction changes for the task 202 (e.g., as described previously in FIGS. 1-2B), and then dividing the sum by one less than the total number of input locations (e.g., input location C1, input location C2, and input location C3).

In step 410, an ergonomics-and-efficiency indicator (e.g., a figure of merit) is generated from the average distance between input locations and the average direction change between input locations. For example, the tracking application 180 calculates a figure of merit by multiplying the average distance between input locations for the task 202, and the average direction change between input locations for the task 202.

In step 412, a determination is made whether the ergonomics-and-efficiency indicator (e.g., the figure of merit) is larger than a target figure of merit. For example, the evaluation module 193 (described previously in FIG. 1) may determine whether the ergonomics-and-efficiency indicator (e.g., the figure of merit) calculated above in the step 410 is greater than a target figure of merit.

In step 414, a recommendation is generated based on whether it is determined that the ergonomics-and-efficiency indicator is larger than the target figure of merit. For example, if the calculated ergonomics-and-efficiency indicator (e.g., the figure of merit) is determined to be greater than the target figure of merit, then the GUI 120 may be classified by the evaluation module 193 as failing to meet ergonomics and efficiency objectives for the task 202, and a recommendation may be generated to redesign the GUI 120 to improve its ergonomics and efficiency.

In step 416, a redesign of the user interface is performed based on the generated recommendation. For example, the evaluation module 193 may perform a redesign process for the GUI 120 in order to ensure that a subsequently calculated ergonomics-and-efficiency indicator (e.g., the figure of merit) for the redesigned GUI 120 is smaller than or equal to the target figure of merit. The redesign process for the GUI 120 may include, for example, identifying the interactive elements (e.g., interactive elements 204/206/208/210 shown previously in FIG. 2A) associated with the vectors calculated in the step 226 of the flowchart 220 that deviate most from the average distance between input locations or the average direction change between input locations, and iteratively adjusting their positions to minimize these deviations. By focusing on these outliers that contribute most to the ergonomics-and-efficiency indicator (e.g., the figure of merit) score and optimizing their placement, the GUI 120 can be systematically redesigned so that the ergonomics-and-efficiency indicator (e.g., the figure of merit) score is equal to or smaller than the target ergonomics-and-efficiency indicator score.

In step 418, the redesigned user interface is visually displayed on an output device. For example, the redesigned GUI 120 may be updated and displayed on the output 194 (e.g., a display screen) as described previously in the step 236 of the flowchart 220.

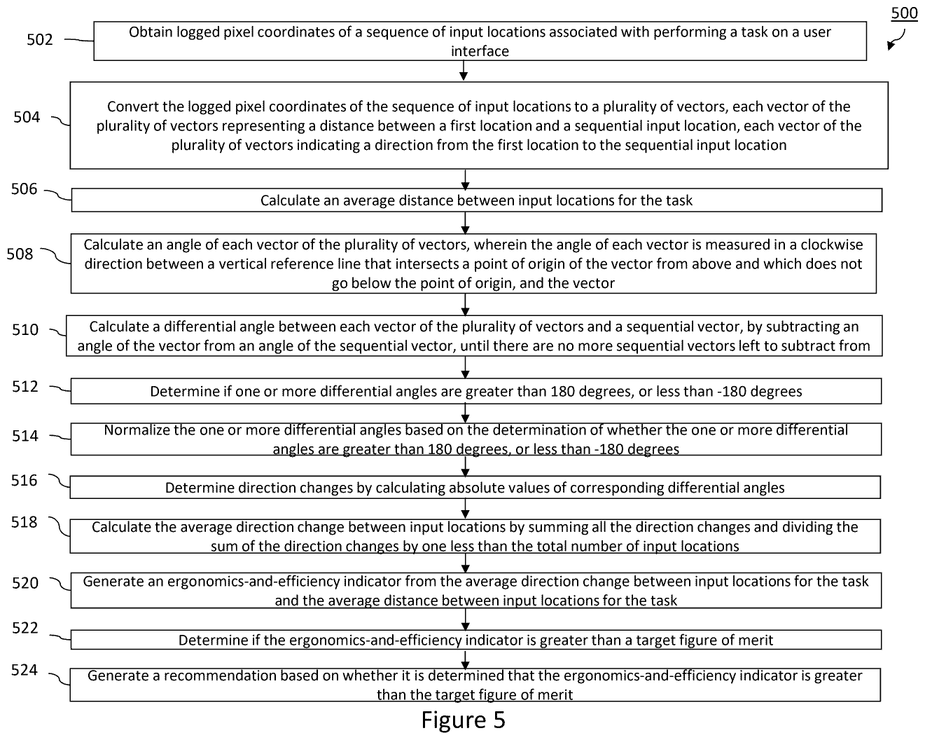

FIG. 5 illustrates an example method 500 for the quantitative evaluation process of the ergonomics and efficiency of the GUI 120 (described previously in FIG. 1) that was described previously in FIGS. 1-3.

In step 502, logged pixel coordinates of a sequence of input locations associated with performing a task on a user interface are obtained. For example, the tracking application 180, or the like, may be executed to monitor and record (e.g., log) an initial cursor (IC) location and/or an input location of a click that the user executes immediately before or while performing each step of the task 202. In addition, the tracking application 180 monitors and records (e.g., logs) the sequence of input locations of the clicks that the user executes to perform the different steps of the task 202.

In step 504, the logged pixel coordinates of the sequence of input locations are converted to multiple vectors. Each vector may represent a distance between a first location and a sequential input location. Each vector may indicate a direction from the first location to the subsequent input location. For example, the tracking application 180 may perform calculations to convert the sequence of input locations recorded in the step 224 of the flowchart 220 to multiple vectors. Each vector may represent a distance (e.g., in pixels, or the like) between the initial cursor (IC) location and the input location C1, or between an input location (e.g., input location C1/C2) and a sequential input location (e.g., input location C2/C3). Each vector also may indicate a direction from the initial cursor (IC) location to the input location C1, or from an input location (e.g., input location C1/C2) to a sequential input location (e.g., input location C2/C3).

In step 506, an average distance between input locations for the task is calculated. For example, the tracking application 180 may sum the distances (e.g., the distance D1+the distance D2+the distance D3 shown in FIG. 2A) of the vectors, and then divide the sum by the total number of input locations (e.g., input location C1, input location C2, and input location C3 shown in FIG. 2A).

In step 508, an angle of each vector of the vectors is calculated. The angle of each vector may be measured in a clockwise direction between a vertical reference line that intersects a point of origin of the vector from above and that does not go below the point of origin, and the vector. For example, as shown in FIG. 2A, an angle of the vector V1 is equal to an angle β1, and the angle β1 is equal to 180 degrees. An angle of the vector V2 is equal to an angle γ1, and the angle γ1 is equal to 180 degrees. An angle of the vector V3 is equal to an angle α1, and the angle α1 may be equal to 120 degrees.

In step 510, a differential angle between each vector of the vectors and a sequential vector is calculated, by subtracting an angle of the vector from an angle of the sequential vector, until there are no more sequential vectors left to subtract from. For example, to determine a first differential angle between the vector V1 and the sequential vector V2, the angle of the vector V1 (e.g., angle β1) may be subtracted from the angle of the sequential vector V2 (e.g., angle γ1). To determine a second differential angle between the vector V2 and the sequential vector V3, the angle of the vector V2 (e.g., angle γ1) may be subtracted from the angle of the sequential vector V3 (e.g., angle α1).

In step 512, it is determined if one or more differential angles are greater than 180 degrees, or less than −180 degrees. In step 514, based on whether it is determined that one or more differential angles are greater than 180 degrees, or less than −180 degrees, the one or more differential angles are normalized. For example, 360 degrees is added to the one or more differential angles if the one or more differential angles are less than −180 degrees, or 360 degrees is subtracted from the one or more differential angles if the one or more differential angles are larger than 180 degrees. In this way, the one or more differential angles are normalized to remain within a range from 180 degrees to −180 degrees.

In step 516, direction changes are determined by calculating absolute values of corresponding differential angles. For example, the absolute value of each differential angle is calculated, the absolute value of the differential angle being a corresponding direction change.

In step 518, the average direction change between input locations is calculated by summing the direction changes and dividing the sum of the direction changes by one less than a total number of input locations. For example, the tracking application 180 may calculate an average direction change between input locations for the task 202. This may be done by summing the calculated direction changes for the task 202, and then dividing the sum by one less than the total number of input locations (e.g., input location C1, input location C2, and input location C3).

In step 520, an ergonomics-and-efficiency indicator (e.g., figure of merit is generated from the average direction change between input locations for the task and the average distance between input locations for the task. For example, the tracking application 180 calculates an ergonomics-and-efficiency indicator by multiplying the average distance between input locations for the task 202, and the average direction change between input locations for the task 202.

In step 522, it is determined if the ergonomics-and-efficiency indicator (e.g., the figure of merit) is greater than a target figure of merit. For example, the target figure of merit may represent the minimum ergonomics and efficiency desired to perform the task 202.

In step 524, a recommendation is generated based on whether it is determined that the ergonomics-and-efficiency indicator (e.g., the figure of merit) is greater than the target figure of merit. For example, if the calculated ergonomics-and-efficiency indicator (e.g., the figure of merit) is determined to be greater than the target figure of merit, then the GUI 120 may be classified by the evaluation module 193 as failing to meet ergonomics and efficiency objectives for the task 202, and a recommendation may be generated to redesign the GUI 120 to improve its ergonomics and efficiency. In certain implementations, the GUI 120 may be redesigned according to the generated recommendation, after which the GUI 120 is updated and displayed on the output 194 (e.g., a display screen).

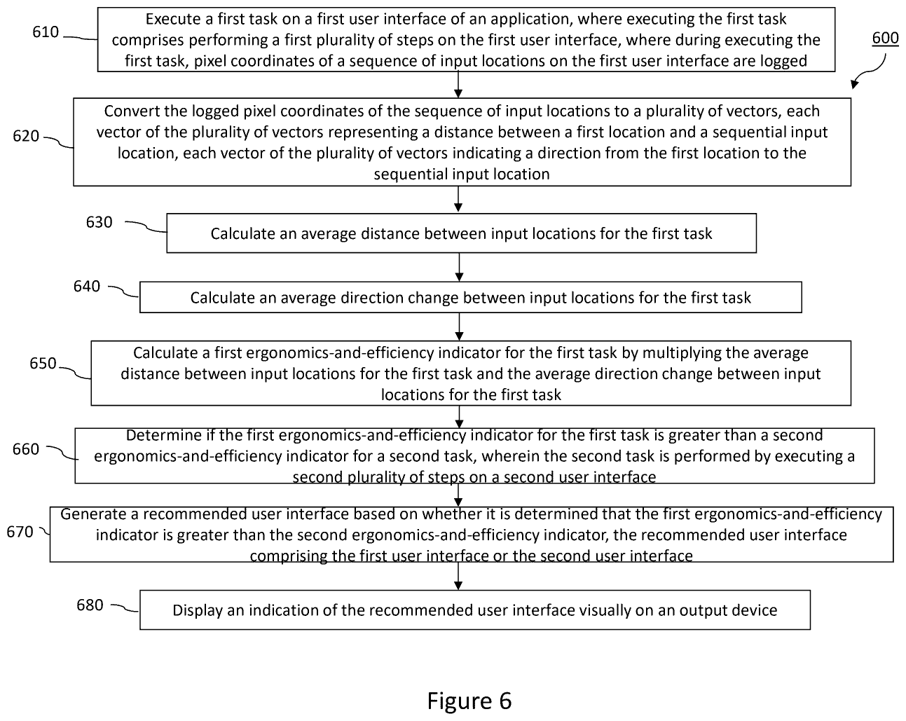

FIG. 6 illustrates an example method 600 for the quantitative evaluation process of the ergonomics and efficiency of a GUI 120 (described previously in FIG. 1) associated with performing a first task, and its comparison with the ergonomics and efficiency of a second GUI associated with performing a second task. The quantitative evaluation process may be performed by the self-adaptive solution described previously in FIGS. 1-5, according to certain implementations.

In step 610, a first task is executed on a first user interface of an application. Executing the first task may include performing a first set of steps on the first user interface. During execution of the first task, pixel coordinates of a sequence of input locations on the first user interface may be logged. For example, the tracking application 180 may be executed to monitor and record (e.g., log) the input location of a click that the user executes immediately before or while performing each step of the task 202. In addition, the tracking application 180 monitors and records (e.g., logs) the sequence of input locations of the clicks that the user executes to perform the different steps of the task 202.

In step 620, the logged pixel coordinates of the sequence of input locations may be converted to multiple vectors. Each vector may represent a distance between a first location and a sequential input location. Each vector may indicate a direction from the first location to the sequential input location. For example, the tracking application 180 performs calculations to convert the sequence of input locations recorded in the step 224 of the flowchart 220 to multiple vectors. Each vector may represent a distance (e.g., in pixels, or the like) between the initial cursor (IC) location and the input location C1, or between an input location (e.g., input location C1/C2) and a sequential input location (e.g., input location C2/C3). Each vector also may indicate a direction from the initial cursor (IC) location to the input location C1, or from an input location (e.g., input location C1/C2) to a sequential input location (e.g., input location C2/C3).

In step 630, an average distance between input locations for the first task is calculated. For example, the tracking application 180 may sum the distances (e.g., the distance D1+the distance D2+the distance D3 shown in FIG. 2A) of the vectors, and then divide the sum by the total number of input locations (e.g., input location C1, input location C2, and input location C3 shown in FIG. 2A).

In step 640, an average direction change between input locations is calculated for the first task. For example, the tracking application 180 may calculate an average direction change between input locations for the task 202. This may be done by summing the calculated direction changes for the task 202 (e.g., as described previously in FIGS. 1-2B), and then dividing the sum by one less than the total number of input locations (e.g., input location C1, input location C2, and input location C3).

In step 650, a first ergonomics-and-efficiency indicator for the first task is calculated by multiplying the average distance between input locations for the first task and the average direction change between input locations for the first task. For example, the tracking application 180 may calculate a first ergonomics-and-efficiency indicator by multiplying the average distance between input locations for the task 202, and the average direction change between input locations for the task 202.

In step 660, it is determined if the first ergonomics-and-efficiency indicator for the first task is greater than a second ergonomics-and-efficiency indicator for a second task. The second task may be performed by executing a second plurality of steps on a second user interface that is different from the first user interface. For example, the calculated first ergonomics-and-efficiency indicator that represents the ergonomics and efficiency associated with performing the task 202 using the GUI 120 can be compared by the evaluation module 193 to a second ergonomics-and-efficiency indicator that represents the ergonomics and efficiency associated with performing a second task using the second GUI. In an implementation, the task 202 and the second task each may include a different number and/or a different sequence of steps in the corresponding tasks. In another implementation, the task 202 and the second task each may include a same number and/or a same sequence of steps in the corresponding tasks. In certain implementations, the second task may be the same as the task 202 except that the second GUI is used to perform the second task rather than the GUI 120. In certain implementations, the task 202 and the second task may represent workflows that are intended to achieve a same overall objective. In certain implementations, the determination of the step 660 could be made by performing any suitable comparison between the first and second ergonomics-and-efficiency indicators (e.g., the first ergonomics-and-efficiency indicator is greater than the second ergonomics-and-efficiency indicator, the second ergonomics-and-efficiency indicator is greater than the first ergonomics-and-efficiency indicator, the first ergonomics-and-efficiency indicator is less than second ergonomics-and-efficiency indicator, or the second ergonomics-and-efficiency indicator is less than the first ergonomics-and-efficiency indicator.

In step 670, a recommended user interface is generated based on whether it is determined that the first ergonomics-and-efficiency indicator is greater than the second ergonomics-and-efficiency indicator. The recommended user interface may comprise the first user interface or the second user interface. For example, if the calculated first ergonomics-and-efficiency indicator is determined to be greater than the second ergonomics-and-efficiency indicator, then the GUI 120 may be classified by the evaluation module 193 as being less ergonomic and efficient than the second GUI, and a recommendation may be generated to utilize the second GUI to perform subsequent tasks instead of the GUI 120.

In step 680, an indication of the recommended user interface is visually displayed on an output device. For example, a recommendation to utilize the second GUI may be loaded and displayed on the output 194 (e.g., a display screen).

It should be understood that the systems and methods described in this disclosure may be combined in any suitable manner.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

The foregoing outlines features of several examples so that those skilled in the art may better understand the aspects of the present disclosure. Various modifications and combinations of the illustrative examples, as well as other examples, will be apparent to persons skilled in the art upon reference to the description. It is therefore intended that the appended claims encompass any such modifications.

What is claimed is:

1. A computer-implemented method, comprising:
obtaining, by a computer system, logged pixel coordinates of a sequence of input locations associated with performing a task on a user interface;
converting, by the computer system, the logged pixel coordinates of the sequence of input locations to a plurality of vectors, each vector of the plurality of vectors representing a distance between a first location and a sequential input location, each vector of the plurality of vectors indicating a direction from the first location to the sequential input location;
calculating, by the computer system, an average distance between input locations for the task;
calculating, by the computer system, an average direction change between input locations for the task;
generating, by the computer system, an ergonomics-and-efficiency indicator from the average distance between input locations and the average direction change between input locations;
determining if the ergonomics-and-efficiency indicator is larger than a target figure of merit;
generating a recommendation based on whether it is determined that the ergonomics-and-efficiency indicator is larger than the target figure of merit;
performing a redesign of the user interface based on the generated recommendation; and
visually displaying the redesigned user interface on an output device.

2. The computer-implemented method of claim 1, wherein calculating the average direction change between input locations for the task comprises:
calculating an angle of each vector of the plurality of vectors, wherein the angle of each vector is measured in a clockwise direction between a vertical reference line that intersects a point of origin of the vector from above and that does not go below the point of origin, and the vector; and
calculating a differential angle between each vector of the plurality of vectors and a sequential vector, by subtracting an angle of the vector from an angle of the sequential vector, until there are no more sequential vectors left to subtract from.

3. The computer-implemented method of claim 2, wherein calculating the average direction change between input locations for the task further comprises:
determining if one or more differential angles are greater than 180 degrees, or less than −180 degrees; and
normalizing the one or more differential angles based on the determination of whether the one or more differential angles are greater than 180 degrees, or less than-180 degrees.

4. The computer-implemented method of claim 3, wherein calculating the average direction change between input locations for the task further comprises determining direction changes by calculating absolute values of corresponding differential angles.

5. The computer-implemented method of claim 4, wherein calculating the average direction change between input locations for the task further comprises:
summing the direction changes to generate a sum; and
dividing the sum of the direction changes by one less than a total number of input locations.

6. The computer-implemented method of claim 1, wherein generating the ergonomics-and-efficiency indicator comprises multiplying the average distance between input locations and the average direction change between input locations for the task.

7. A computer-implemented method, comprising:
executing, by a computer system, a first task on a first user interface of an application, wherein executing the first task comprises performing a first plurality of steps on the first user interface, wherein during executing the first task, pixel coordinates of a sequence of input locations on the first user interface are logged to obtain logged pixel coordinates of the sequence of input locations;
converting, by the computer system, the logged pixel coordinates of the sequence of input locations to a plurality of vectors, each vector of the plurality of vectors representing a distance between a first location and a sequential input location, each vector of the plurality of vectors indicating a direction from the first location to the sequential input location;
calculating, by the computer system, an average distance between input locations for the first task;
calculating, by the computer system, an average direction change between input locations for the first task;
calculating, by the computer system, a first ergonomics-and-efficiency indicator for the first task by multiplying the average distance between input locations for the first task and the average direction change between input locations for the first task;
determining, by the computer system, whether the first ergonomics-and-efficiency indicator for the first task is greater than a second ergonomics-and-efficiency indicator for a second task, wherein the second task is performed by executing a second plurality of steps on a second user interface;
generating a recommended user interface based on whether it is determined that the first ergonomics-and-efficiency indicator is greater than the second ergonomics-and-efficiency indicator, the recommended user interface comprising the first user interface or the second user interface; and
visually displaying an indication of the recommended user interface on an output device.

8. The computer-implemented method of claim 7, wherein the first location is an initial cursor location or a click location, and the sequential input location is a click location, and wherein a number of steps of the first plurality of steps is different from a number of steps of the second plurality of steps.

9. The computer-implemented method of claim 7, wherein the first location is an initial cursor location or a click location, and the sequential input location is a click location, and wherein a number of steps of the first plurality of steps is the same as a number of steps of the second plurality of steps.

10. The computer-implemented method of claim 7, wherein calculating the average distance between input locations for the first task comprises:
summing the distances of the plurality of vectors to generate a sum; and
dividing the sum by a total number of input locations.

11. The computer-implemented method of claim 7, wherein calculating the average direction change between input locations for the first task comprises:
calculating an angle of each vector of the plurality of vectors, wherein the angle of each vector is measured in a clockwise direction between a vertical reference line that intersects a point of origin of the vector from above and that does not go below the point of origin, and the vector; and
subtracting an angle of each vector from an angle of a sequential vector, until there are no more sequential vectors left to subtract from, in order to obtain a differential angle between each vector and a sequential vector.

12. The computer-implemented method of claim 11, wherein calculating the average direction change between input locations for the first task further comprises normalizing each differential angle to be within a range from 180 degrees to −180 degrees.

13. The computer-implemented method of claim 11, wherein calculating the average direction change between input locations for the first task further comprises obtaining direction changes by calculating absolute values of corresponding differential angles.

14. The computer-implemented method of claim 13, wherein calculating the average direction change between input locations for the first task further comprises:
summing the direction changes to generate a sum; and
dividing the sum of the direction changes by one less than a total number of input locations.

15. A system, comprising:
one or more processors; and
one or more non-transitory computer-readable storage media storing programming for execution by the one or more processors, the programming comprising instructions to:
obtain logged pixel coordinates of a sequence of input locations on a user interface associated with performing a task on the user interface;
convert the logged pixel coordinates of the sequence of input locations to a plurality of vectors, each vector of the plurality of vectors representing a distance between a first location and a sequential input location, each vector of the plurality of vectors indicating a direction from the first location to the sequential input location;
calculate an average distance between input locations for the task by summing the distances of the plurality of vectors to generate a sum, and then dividing the sum by a total number of input locations;
calculate an average direction change between input locations for the task;
generate an ergonomics-and-efficiency indicator from the average distance between input locations and the average direction change between input locations;
determine if the ergonomics-and-efficiency indicator is larger than a target figure of merit;
generate a recommendation based on whether it is determined that the ergonomics-and-efficiency indicator is larger than the target figure of merit;
perform a redesign of the user interface based on the generated recommendation; and
visually display the redesigned user interface on an output device.

16. The system of claim 15, wherein calculating the average direction change between input locations for the task comprises calculating an angle of each vector of the plurality of vectors, wherein the angle of each vector is measured in a clockwise direction between a vertical reference line that intersects a point of origin of the vector from above and that does not go below the point of origin, and the vector.

17. The system of claim 16, wherein calculating the average direction change between input locations for the task further comprises calculating a differential angle between each vector of the plurality of vectors and a sequential vector, by subtracting an angle of the vector from an angle of the sequential vector, until there are no more sequential vectors left to subtract from.

18. The system of claim 17, wherein calculating the average direction change between input locations for the task further comprises determining direction changes by calculating absolute values of corresponding differential angles.

19. The system of claim 18, wherein calculating the average direction change between input locations for the task further comprises summing the direction changes to generate a sum, and dividing the sum by one less than a total number of input locations.

20. The system of claim 15, wherein generating the ergonomics-and-efficiency indicator comprises multiplying the average direction change between input locations for the task and the average distance between input locations for the task.
